(19) United States
(12) Patent Application Publication
(10) Pub. No.: US 2009/0162921 A1
(43) Pub. Date: Jun. 25, 2009

(54) Method of detoxifying a harmful compound

(75) Inventors: Koji Fujita, Tokyo (JP); Akihiro Hishinuma, Tokyo (JP); Shinji Kamiya, Tokyo (JP); Koichiro Nakamura, Tokyo (JP); Takakiyo Tada, Kyoto (JP); Hiroshi Yamauchi, Kanagawa (JP)

Correspondence Address: HAMRE, SCHUMANN, MUELLER & LARSON, P.C., P.O. BOX 2902, MINNEAPOLIS, MN, 55402-0902, US

(73) Assignee: Nippon Sheet Glass Company, Limited, Tokyo (JP)

(21) Appl. No.: 11/988,765

(22) PCT Filed: Jul. 11, 2006
(86) PCT No.: PCT/JP2006/314120

§ 371 Date: Mar. 25, 2008

(30) Foreign Application Priority Data
Jul. 14, 2005 (JP) 2005-205727
Jan. 23, 2006 (JP) 2006-013636

(51) Int. Cl. A62D 3/02

(52) U.S. Cl. 435/262.5

(57) ABSTRACT

The detoxification method characterized by comprising converting at least one member selected from the group comprising arsenic, antimony and selenium into a harmless substance produced in a food chain system by using the food chain system. The method of detoxifying a harmful compound as described above is characterized by comprising converting a harmful compound containing at least one element selected from the group comprising arsenic, antimony, and selenium into a harmless substance by using a food chain system containing a larval zooplankton.

### TECHNICAL FIELD

The present invention relates to a method of detoxifying arsenic etc., using the food chain system. Furthermore, the invention relates to a method of detoxifying a harmful compound. In particular, the invention relates to a method of detoxifying a harmful compound containing at least one selected from the group comprising arsenic, antimony and selenium.

### BACKGROUND ART

Arsenic is designated as a specified toxic substance of the Soil Contamination Countermeasures Law. Actually, a purification method using an absorbent is conducted.

Although the inorganic arsenic among arsenic has high poisonous property, it is generally known that as the arsenic is methylated, it become more harmless. The table 1 shows a LD₅₀ value (oral toxicity based on the dosage of drugs which 50% of the used experimental animal died.) of the arsenic in the various sort of the step of the methylation. As can be clear from table 1, it is recognized that a trimethyl arsenic such as, arsenocholine, trimethylarsineoxide, and arsenobetaine, has very low drug toxicity. In particular, the LD₅₀ value of arsenobetaine which is one of the trimethyl arsenic and which is contained in a sea food with large amount, is 10000, and therefore, it is innoxious substance compared to a sugar. Furthermore, a produced arsenobetaine is a stable substance, it is not likely to occur the demethylation and degradation of arsenobetaine. It is stable over the long period of time under the ordinary circumstances. Arsenobetaine do not go back to the poisonous demethylated arsenical apecies, if it is not exposed to the decomposition reactions through a certain specific microorganism or the chemical reactions under the very high temperature.

TABLE 1

| | Chemical species of arsenic | LD₅₀(mg/kg) |
|---|---|---|
| As(III) | inorganic arsenic(III(valency)) | 4.5 |
| As(V) | inorganic arsenic(V(valency)) | 14-18 |
| MMA | monomethyl arsonic acid | 1,800 |
| DMA | dimethylarsinic acid | 1,200 |
| AC | arsenocholine | 6,000 |
| TMAO | trimethylarsineoxide | 10,600 |
| AB | arsenobetaine | 10,000 |

Moreover, FIG. 1 shows a pathway of the methylation of arsenic in a mammal, and FIG. 2 shows a structure of arsenobetaine, respectively.

In a viewpoint of such knowledge, it is theoretically possible to methylate the inorganic arsenic with an artificial chemical reaction for the detoxification of the inorganic arsenic.

On the other hand, as a method of treating arsenic using a food chain system, a method for methylating the inorganic arsenic using the model food chain system comprising three steps, that is, a chlorella—a ceriodaphnia dubia—a guppy is researched (Shigeru Maeda, chemical engineering society, annual summary, pages 12-13, 1993). In this reference, 82.4% of a total arsenic can be converted to a methylated arsenic (dimethyl arsenic, trimethyl arsenic) in a guppy which the arsenic is finally stored in. In the reference, however, it is shown as the result that 17.6% of the inorganic arsenic still stayed, which has a high toxicity. According to the method, it is possible to collect and store arsenic using the individual organism of the guppy.

Moreover, a food chain system comprising a chlorella—a pond crevettes—a rice fish is also came under review (Takayoshi Kuroiwa et al, Biomed Res Trace Elements 9(3), 1998, p167-168).

Furthermore, the heavy metal material such as arsenic, antimony and selenium is widely used as an industrial material, for example, semiconductor, but the influence on the organism by being flowed it out into an environment is concerned since it is harmful material for the organism.

In the past, as a method for treating these heavy metal, the method wherein a flocculating agent such as polyaluminum chloride (PAC) is added into the wastewater containing an inorganic arsenic such as a harmful arsenous acid, and then the inorganic arsenic is removed by the filtration after the inorganic arsenic is aggregated, adsorbed to the flocculating agent and iron contained in a raw water and then precipitated, or a method wherein an arsenic compound etc. is adsorbed by using an activated alumina, cerium based flocculating agent etc., are generally known.

On the other hand, in nature, there are several classes of the algae having an ability of taking up and accumulating the inorganic arsenic existing in the environment. Up to now, as the algae having an ability of taking up and accumulating the inorganic arsenic, several classes of the microalgae such as chlorella are known. Although most of arsenic is accumulated as the inorganic arsenic in the body of the algae, it is know that the rest is accumulated in the conformation of the methylation (Maeda et al., 1990, Appl. Organomet. Chem., 4, 251-254, and Gossler et al., 1997, Appl. Organomet. Chem., 11, 57-66). And it is generally known that these organic arsenic compound has lower toxicity than that of the inorganic arsenic for the mammal.

In a viewpoint of such knowledge, as a specific method of collecting arsenic using the algae, a method of collecting and detoxifying arsenic existing in the environment and the wastewater is suggested that the resistance of the algae to arsenic is enhanced by destroying the PTB1 gene which is responsible for the resistance to arsenic (JP-A-2003-265186).

However, the treating method according to the artificial chemical reactions gives a difficulty to accomplish it practically including the control etc., of the intermediate product. Moreover, there are issue of safety because such process is very dangerous and is needed for a complicated process.

There are the following problems as to the treatment of arsenic. Therefore, an early development for the effective treatment of arsenic have been desired:

1. The arsenic is designated as a specified toxic substance by the Soil Contamination Countermeasures Law. Actually, methods for cleaning it up by using an absorbent are used. However, as an inorganic arsenic after the absorptive treatment has still high poisonous property, and it is difficult to store, and therefore, a method of treating and storing an inorganic arsenic safely has been needed.
2. The art of the control subjects which are used in the water system at the moment is conducted with a filter for the absorptive treatment of arsenic. In the absorptive treatment, however, there are still problems such as, the shortage of the throughput, insufficiency of the adsorptive treatment from a viewpoint of the material balance. Furthermore, safe measures for store are also needed, and therefore, engineering developments for solving the above problems are urgently needed.
3. Arsenious acid comes about as a secondary product in the nonferrous smelting such as a copper concentrate. The arsenious acid produced by the nonferrous smelting has been treated as clarificant for a glass in the past. However, such treatments can not be conducted from now on.
4. A sump water spring forth from empty lots in a metalliferous mine is also the same situation as the above mentioned. Such sump water is out of the control subjects. However, there are no solution about an contaminated arsenic in water.
5. Furthermore, in a semiconductor industry which semiconducting crystal of arsenic containing compound is used, there are still problems that the inorganic arsenic is exposed. Therefore, as to the method of treating the inorganic arsenic, engineering developments for solving the above problems are urgently needed.

As mentioned above, although it is possible to collect the inorganic arsenic from the environment using a ferric chloride, cesium hydroxide or chelating agent and or the like, the safe means for the detoxification of the collected inorganic arsenic is poor in the past. Therefore, it is commonly used that the collected inorganic arsenic is deposited on the back-filling plant or disposal field in a mine, or the arsenic-contaminant part is enclosed with a concrete. Therefore, there are a lot of problems that a large space such as a disposal site is needed, and that harmful inorganic arsenic elute off again. These problems are the same as in a method of collecting and storing an arsenic efficiently concentrated in a narrow space under safe condition.

Moreover, according to the method comprising three steps of a chlorella—a ceriodaphnia dubia—a guppy as mentioned above, it is not enough for the methylation because most of the inorganic arsenic having a high toxicity still remains. Further, there were problems that since the fish contains a lot of amount of water in their body, it is difficult to dry and is not suitable for storage.

Further, in the food chain system made of a chlorella—a paratya compressa compressa—a rice-fish, it is reported that 20% of the inorganic arsenic still remains because the biological accumulation of arsenic does not occur, and therefore, a method of detoxifying the inorganic arsenic efficiently is desired. Further, it is desired that a method of separating off an accumulated and detoxified arsenic for the final organism of the food chain system industrially and effectively. Further, as the final organism those having an ability of mathylating the inorganic arsenic surely are desired, even if the inorganic arsenic is industrially contaminated by some reasons.

Therefore, under present circumstances, a new development of a method of detoxifying the inorganic arsenic safety and efficiently, or further a method of accumulating and storing the detoxified arsenic under the concentrated condition as long as possible are desired.

Further, in the method according to the use of the absorbent as mentioned above, it has poor throughput and is not enough for the adsorptive treatment from a viewpoint of the material balance. Furthermore, safe measures for store are also not enough.

Furthermore, there are still problems that most of the accumulated arsenic into the body of the algae still remains as the inorganic arsenic having a high toxicity in the method of collecting arsenic by using the microalgae as mentioned above.

Therefore, it is an object of the present invention to provide a new method of detoxifying the inorganic arsenic safely and effectively. Further, it is an object of the present invention to provide a method of accumulating and storing the detoxified arsenic under the concentrated condition as long as possible, and thereby, to provide a system of treating arsenic which is suitable for the industrialization.

Therefore, it is an object of the present invention to provide a method of detoxifying the harmful compound containing arsenic etc., effectively.

### DISCLOSURE OF INVENTION

In order to accomplish the above objects, the present inventors made strenuous studies on the detoxification of arsenic effectively including from collecting arsenic to storing it. As a result, the inventors discovered the method of detoxifying arsenic according to the present invention. Further, the present inventors tried to convert the harmful compound containing arsenic etc., to the harmless substance by using the food chain system containing several sort of the zooplankton and made strenuous studies on the ability of detoxifying the harmful compound which the detoxification of arsenic effectively including the experiment from collecting arsenic to storing it. As a result, the inventors discovered the method of detoxifying the harmful compound according to the present invention.

That is, a method of detoxifying a harmful compound according to the present invention is characterized in that an element selected from the group comprising arsenic, antimony and selenium, or the harmful compound containing at least one element selected from the group comprising arsenic, antimony and selenium are converted to a harmless substance using a food chain system.

Further, in a preferred embodiment of the method of detoxifying the harmful compound according to the present invention, the method is characterized in that using the food chain system at least one element selected from the group comprising arsenic, antimony and selenium is converted to a harmless substance produced by the food chain system.

Further, in a preferred embodiment of the method of detoxifying the harmful compound according to the present invention, the method is characterized in that the food chain system is a phytoplankton—a zooplankton.

Further, in a preferred embodiment of the method of detoxifying the harmful compound according to the present invention, the method is characterized in that the food chain system is further made of a shellfish after the zooplankton.

Further, in a preferred embodiment of the method of detoxifying the harmful compound according to the present invention, the method is characterized in that the phytoplankton is a microalgae.

Further, in a preferred embodiment of the method of detoxifying the harmful compound according to the present invention, the method is characterized in that the microalgae is a chlorella.

Further, in a preferred embodiment of the method of detoxifying the harmful compound according to the present invention, the method is characterized in that the zooplankton is an artemia or a rotifer.

Further, in a preferred embodiment of the method of detoxifying the harmful compound according to the present invention, the method is characterized in that the food chain system comprises feeding a solution containing an organism and/or a dimethylated arsenic compound or cacodylic acid to the shellfish.

Further, in a preferred embodiment of the method of detoxifying the harmful compound according to the present invention, the method is characterized in that the shellfish is a shellfish capable of being farmed.

Further, in a preferred embodiment of the method of detoxifying the harmful compound according to the present invention, the method is characterized in that the shellfish is an oyster.

Further, in a preferred embodiment of the method of detoxifying the harmful compound according to the present invention, the method is characterized in that the shellfish is bred under the existence of a methylating accelerator factor.

Further, in a preferred embodiment of the method of detoxifying the harmful compound according to the present invention, the method is characterized in that the methylating accelerator factor is glutathione, S-adenosylmethionine or sulforaphane.

Further, in a preferred embodiment of the method of detoxifying the harmful compound according to the present invention, the method is characterized in that the concentration of the inorganic arsenic is reduced to less or equal to a concentration of an inorganic arsenic contained in a sea food of nature, and the inorganic arsenic is converted to a harmless organic arsenic.

Further, in a preferred embodiment of the method of detoxifying the harmful compound according to the present invention, the method is characterized in that the harmful compound containing at least one element selected from the group comprising arsenic, antimony and selenium is converted to a harmless substance using a food chain system containing a zooplankton in the larval stage.

Further, in a preferred embodiment of the method of detoxifying the harmful compound according to the present invention, the method is characterized in that the element is arsenic.

Further, in a preferred embodiment of the method of detoxifying the harmful compound according to the present invention, the method is characterized in that the food chain system is a food chain system made of a microalgae—a zooplankton in the larval stage.

Further, in a preferred embodiment of the method of detoxifying the harmful compound according to the present invention, the method is characterized in that the harmful compound is converted to the harmless substance by methylating the harmful compound using a biological enzyme of the microalgae and the larval zooplankton.

Further, in a preferred embodiment of the method of detoxifying the harmful compound according to the present invention, the method is characterized in that the microalgae is a marine-derived microalgae.

Further, in a preferred embodiment of the method of detoxifying the harmful compound according to the present invention, the method is characterized in that the marine-derived microalgae is a microalgae which is belong to Nannochloropsis genus.

Further, in a preferred embodiment of the method of detoxifying the harmful compound according to the present invention, the method is characterized in that the zooplankton is an artemia.

Further, in a preferred embodiment of the method of detoxifying the harmful compound according to the present invention, the method is characterized in that the harmful compound is converted to a monomethyl compound, a dimethyl compound and/or a trimethyl compound by the methylation.

Further, in a preferred embodiment of the method of detoxifying the harmful compound according to the present invention, the method is characterized in that the dimethyl compound is at least one selected from the group comprising arsenosugar, dimethylarsinic acid, dimethylarsinoyl acetate (DMAA), dimethylarsinoyl ethanol (DMAE), dimethylarsinoyl propionate (DMAP).

Further, in a preferred embodiment of the method of detoxifying the harmful compound according to the present invention, the method is characterized in that the trimethyl compound is at least one selected from the group comprising arsenocholine, arsenobetaine and trimethylarsineoxide.

Further, in a preferred embodiment of the method of detoxifying the harmful compound according to the present invention, the method is characterized in that the trimethyl compound is made of arsenobetaine.

Further, in a preferred embodiment of the method of detoxifying the harmful compound according to the present invention, the method is characterized in that the concentration of the inorganic arsenic is reduced to less or equal to a concentration of an inorganic arsenic contained in a sea food of nature, and the inorganic arsenic is converted to a harmless organic arsenic.

### EFFECT OF INVENTION

The method of the present invention has an advantageous effect that it has a high stability compared to the methylation by the chemical reactions. Further, the method of the present invention has an advantageous that it is possible to detoxify and methylate arsenic more efficiently and to reduce the residual inorganic arsenic more than those method using the known food chain system made of a guppy. Further, the method of the present invention has an advantageous effect that it provides a method of detoxifying the harmful compound containing arsenic etc., effectively.

### BRIEF DESCRIPTION OF THE DRAWINGS

For a better understanding of the invention, reference is made to the attached drawings, wherein:

FIG. 1 gives a methylation pathway of arsenic in mammal class.

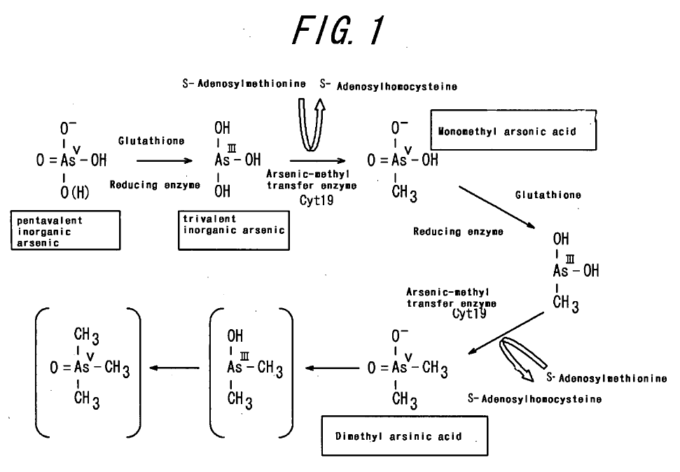

FIG. 2 gives a structure of arsenobetaine.

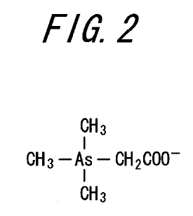

FIG. 3 gives a graph showing the time course as to the concentration of the inorganic arsenic and the organic arsenic accumulated in the cell of the algae, Nannochloropsis, and the concentration of the algae.

FIG. 4 gives a graph showing the percentage of the inorganic arsenic, the monomethyl arsenic compound, and dimethyl arsenic compound accumulated in the cell of the algae, Nannochloropsis.

### BEST MODE FOR CARRYING OUT THE INVENTION

The detoxification method according to the present invention is characterized in that an element selected from the group comprising arsenic, antimony and selenium, or the harmful compound containing at least one element selected from the group comprising arsenic, antimony and selenium are converted to a harmless substance using a food chain system. That is, according to the detoxification method of the present invention, it is possible to convert at least one element selected from the group comprising arsenic, antimony and selenium into a harmless substance, and it is also possible to convert the harmful compound containing at least one element selected from the group comprising arsenic, antimony and selenium into a harmless substance. This is because the inventors found the excellent purifying effect of the food chain system by their knowledge.

The detoxification method according the present invention make it possible to convert at least one selected from the group comprising arsenic, antimony and selenium into a harmless substance produced by the food chain system using the food chain system. The term “using the food chain system” used herein widely means that using several sort of the enzyme of the organism, an inorganic substance comprising at least one elected from the group comprising arsenic, antimony and selenium is converted to the harmless organic substance.

In the present invention, as the food chain system, mention may be made of a phytoplankton—a zooplankton etc., from the viewpoint of the industrialization and the commercial viability. The term “the food chain system comprising a phytoplankton—a zooplankton” used herein means a food chain system comprising accumulating arsenic into the phytoplankton, and thereby accumulating the phytoplankton in which arsenic is uptaken into the zooplankton.

The phytoplankton is not specifically limited, but mention may be made of the microalgae such as a chlorella, a seaweed class and a layer.

The other phytoplankton may be used as long as it attains the effect of the collection and methylation of arsenic. Since the chlorella used in the following examples is, in general, commercially available and suitable for the mass production, and therefore, in particular, the use of the chlorella in the present invention is preferable embodiment. The phytoplankton used in the present invention may be, however, a phytoplankton other than the chlorella as long as is has an effect that it can absorb the inorganic arsenic contained in the solution in a short period of time. Moreover, the organism used in the first step is not necessarily limited to the phytoplankton, it is also possible to use the other organism as long as it may collect arsenic and it is an object for the ingestion of the organism in the next step. Moreover, in the above food chain system, the chlorella (Chlorella regularis, green algae, classification of chlorella) aims at the collection and methylation of the inorganic arsenic from seawater.

As the zooplankton, mention may be made of an artemia, a rotifer, a copepoda and an arrowworm etc., but it is not limited. The other zooplankton may be used as long as it attains the effect of the methylation and detoxification of the inorganic arsenic. That is, the zooplankton used in the present invention may be those capable of accelerating the methylation of arsenic with no increase of the amount of the inorganic arsenic contained in the organism of the previous step. In particular, the use of the artemia in the following example is preferable embodiment. The artemia is the marine zooplankton which has 0.5 to 1.0 mm of the full length, and is known as a sea monkey. The artemia is used as a bait for a fish and shellfish immediately after the hatch in cultural fishery. Moreover, the organism used in the second step is not necessarily limited to the zooplankton. The artemia which accumulates the phytoplankton such as the chlorella (Artemia saline, Crustacea, classification of Anostraca), mainly aims at accelerating of the further methylation of arsenic.

In the present invention, preferably, a shellfish may be appropriate after the food chain system of the phytoplankton—the zooplankton from the viewpoint of the industrialization and the commercial viability. The shellfish class makes it possible to convert the dimethyl arsenic compound etc., as the starting material into a detoxified arsenic which is mainly made of the trimethyl arsenic (arsenobetaine) to accumulate the detoxified arsenic in the shellfish.

In this case, the shellfish is preferably a shellfish capable of being farmed from the viewpoint of the industrialization and the commercial viability. The shellfish is preferably an oyster from the viewpoint that it may have an ability of the methylation and only a methylated arsenic of a high order. Moreover, the term “capable of being farmed” widely includes several sort of a shellfish generally farmed for the application as food etc. The other shellfish may be used as long as it attains the effect capable of collecting the detoxified arsenic. The organism of the final stage of the food chain system used in the present invention may make it possible to concentrate the arsenic compounds etc., and accumulate and store them stably. The use of the shellfish class at the final stage of the food chain has an advantage that it is possible to separate the shell from the fillet of the shellfish. Therefore, the application of the system of treating arsenic according to the food chain system comprising using the shellfish at the final stage which makes it easy to collect and treat the detoxified arsenic make it possible to produce a complete-closure system of treating arsenic industrially and effectively. The shellfish class plays a role in accumulating and concentrating the detoxified and methylated arsenic in the body of them, and further plays a role in making it easy to collect the individual organism containing the methylated arsenic from the seawater, by their uptaking the zooplankton such as the artemia which accumulates arsenic.

In a preferred embodiment of the method of detoxifying the harmful compound, the food chain system comprises feeding a solution containing an organism and/or a dimethylated arsenic compound or cacodylic acid to the shellfish class. This is because the shellfish class such as the oyster itself has an ability of the methylation. That is, this is because the shellfish makes it possible to convert cacodylic acid or the dimethylated arsenic compound etc., into the trimethyl compound, namely the harmless substance if cacodylic acid or the dimethylated arsenic compound etc., exist in the seawater and the shellfish accumulates cacodylic acid etc., since the shellfish has an ability of accumulating everything as long as it exists in the seawater. This makes it possible to not only accumulate the detoxified arsenic, but also convert it to more methylated substance of a higher order. Since the shellfish class such as the oyster is located in upper level of the organism in the food chain system compared to the plankton, an amount of accumulating the detoxified arsenic is large, and therefore it attains the larger amount of the detoxification.

In a preferred embodiment of the present invention, the treatment may be carried out under the existence of a methylating accelerator factor. The methylating accelerator factor is not specifically limited as long as it can accelerate the methylation of arsenic etc., but includes for example, glutathione, reduced form of glutathione (GSH), betaine, S-adenosylmethionine or sulforaphane etc.

The application of the food chain system under the existence of a methylating accelerator factor for arsenic such as reduced form of glutathione (GSH) further make it possible to accelerate the accumulation and concentration of the trimethyl arsenic. Therefore, breeding the shellfish etc., under the circumstance containing the methylating accelerator factor make it possible to attain a higher effect in the present invention. It is thought that the conversion to the arsenobetaine may be accelerated by adding those substances, although it is thought that a reducing ability for arsenic or the transmethylation reaction are likely to be a rate controlling in the conversion to arsenobetaine. Therefore, the use of the methylating accelerator factor such as GSH and or the like produces an industrial system of treating arsenic capable of accumulating and storing trimethylated arsenic into the shellfish under the further concentrated condition.

Further, in a preferred embodiment, the concentration of the inorganic arsenic is reduced to less or equal to a concentration of an inorganic arsenic contained in a sea food of nature, and the inorganic arsenic is converted to a harmless organic arsenic. At this moment, the term “less or equal to a concentration of an inorganic arsenic contained in a sea food of nature” means less or equal to a concentration of an inorganic arsenic naturally contained in a sea food under the circumstance with no contamination caused by arsenic etc. That is, according to the method of the present invention, in the food chain system, it is possible to reduce the concentration of the inorganic arsenic to less or equal to that contained in the sea food of nature simultaneously to convert it to more stable and harmless organic arsenic.

Next, the method of detoxifying the harmful compound will be explained. In the following, in particular, it will be explained by citing the example in that at least one element selected from the group comprising arsenic, antimony and selenium, or the harmful compound containing at least one element selected from the group comprising arsenic, antimony and selenium are converted to a harmless substance using a food chain system containing a zooplankton in the larval stage. That is, according to the detoxification method of the present invention, it is possible to convert at least one element selected from the group comprising arsenic, antimony and selenium into a harmless substance, and it is also possible to convert the harmful compound containing at least one element selected from the group comprising arsenic, antimony and selenium into a harmless substance. In particular, in the following, the present invention will be explained in the case of the detoxification of the harmful compound, but as mentioned above, it is clear that the present invention also make it possible to convert at least one element (simple substance) selected from the group comprising arsenic, antimony and selenium into a harmless substance,

The present invention is characterized in that the harmful compound containing at least one element selected from the group comprising arsenic, antimony and selenium is converted into a harmless substance by using the food chain system containing the zooplankton in the larval stage. The term “the harmful compound” used herein means a compound which gives any adverse affect to the organism when it is exposed to the organism in the environment.

As a harmful compound containing arsenic among the harmful compound, mention may be made of arsenious acid, arsenic pentoxide, arsenic trichloride, arsenic pentachloride, arsenic sulfide compound, cyano arsenic compound, chloro arsenic compound, and other arsenic inorganic salt and or the like. In these arsenic, for example, a LD₅₀ (50% of the fatal dose in mouse) is less or equal to 20, and therefore, it is generally a poisonous value for the organism.

Further, as a harmful compound containing antimony, mention may be made of antimony trioxide, antimony pentoxide, antimony trichloride, and antimony pentachloride and or the like.

Furthermore, as a harmful compound containing selenium, mention may be made of selenium dioxide, selenium trioxide and or the like.

In the present invention, the detoxification of the harmful compound as mentioned above is carried out by using the food chain system containing the zooplankton in the larval stage. The term “using the food chain system containing the zooplankton in the larval stage” used herein widely means that using several sort of the enzyme of the organism, the harmful compound is converted to the harmless substance.

In the present invention, as the food chain system containing the zooplankton in the larval stage, mention may be made of, for example, a microalgae—a zooplankton in the larval stage from the viewpoint that the culture is easy as a bait for the zooplankton. The term “the food chain system comprising a microalgae—a zooplankton” used herein means a food chain system comprising accumulating arsenic into the microalgae, and thereby accumulating the microalgae in which the harmful compound is uptaken into the larval zooplankton.

The detoxification of the harmful compound as mentioned above using the food chain system of the microalgae—the larval zooplankton specifically may be carried out by methylating the harmful compound by the biological enzyme of the microalgae and the larval zooplankton to convert the harmful compound into the harmless substance.

At this moment, as an example, if the toxicity as to both the harmful compound containing arsenic and a methylated compound of the harmful compound will be explained, LD₅₀, (50% of the fatal dose in mouse) of arsenous acid which is the inorganic arsenic is 4.5 mg/kg, while LD₅₀ of arsenic acid is 14-18 mg/kg. On the other hand, LD₅₀ of the monomethylated arsenic (monomethyl arsonic acid) is 1800 mg/kg, LD₅₀ of the dimethylated arsenic (dimethyl arsinic acid) is 1200 mg/kg. Further, in the trimethylated arsenic, LD₅₀ of arsenocholine is 6000 mg/kg, LD₅₀ of trimethylarsinic oxide is 10600 mg/kg, and LD₅₀ of arsenobetaine is 10000 mg/kg. Therefore, it is clear that the toxicity of the harmful compound is reduced by the methylation considering these value of LD₅₀. The present inventors found that the present invention makes it possible to attain these effect by using a useful microalgae and larval zooplankton, particularly, the biological enzyme.

The microalgae as mentioned above includes the freshwater microalgae and the marine microalgae, is not particularly limited. However, in the present invention, the marine-derived microalgae is preferable which has a higher ability of methylating the above harmful compound. However, the freshwater microalgae may be sufficiently used in the present invention because their ability of methylating the harmful compound may be enhanced by changing the culture condition properly.

As the marine-derived microalgae as mentioned above, mention may be made of a marine-derived microalgae belonging to Nannochloropsis genus. This marine-derived microalgae belonging to Nannochloropsis genus has a high ability of methylating the harmful compound, especially, a high ability of dimethylation. As the marine-derived microalgae belonging to Nannochloropsis genus, mention may be made of, for example, Nannochl oropsis oculate, Nannochloropsis saline, Nannochloropsis gaditana, Nannochloropsis granulate etc. These marine-derived microalgae belonging to Nannochloropsis genus are suitable for detoxifying the harmful compound industrially because they are used as a feeding stuff of the young fish at the cultural fishery etc., and the culture technique in mass production is confirmed.

As the freshwater microalgae as mentioned above, mention may be made of a microalgae belonging to chlorella genus. As the microalgae belonging to chlorella genus, mention may be made of, for example, Chlorella regularis, Chlorella vulgaris, Chlorella ellipsoidea, Chlorella fusca var fusca, Chlorella fusca var vacuolata, Chlorella kessleri, Chlorella protothecoi des var mannophila, Chlorella protothecoides, Chlorella pyrenoidosa, Chlorella saccharophila, Chlorella sorokiniana and Chlorella zofingiensis etc. These microalgae belonging to chlorella genus are also suitable for detoxifying the harmful compound industrially because the culture technique in mass production is confirmed.

As the zooplankton as mentioned above, mention may be made of for example, an artemia. The larval of the zooplankton makes it possible to convert the harmful compound methylated in the cell of the microalgae into more harmless substance by more methylation. In addition to this, it is easy to control them by feeding a bait for short time immediately after the hatch. On the other hand, in the case of an adult zooplankton, feeding a bit is required from for several weeks to about one month, it takes a long time for the preparation. In addition to this, it is very difficult to bring them up to the adult from the hatched individual and they give poor yield ratio. At this moment, in the present invention, the larval zooplankton is preferably a zooplankton within 7 days after the hatch, more preferably a zooplankton within 1 to 4 days after the hatch, from the viewpoint of avoiding the increase of the died individual, the degradation of yield ratio and the contamination of the died individual to the feeding stuff. The zooplankton is preferably an artemia from the viewpoint that the ability of methylating is higher, and it is possible to use easily by hatching eggs. Furthermore, the artemia is used as a feeding stuff for the young fish at the cultural fishery etc., the culture technique in mass production is confirmed. Therefore, the artemia is suitable for detoxifying the harmful compound industrially.

Moreover, in the detoxification method of the present invention, it is preferable to convert the harmful compound to the monomethyl compound and/or the dimethyl compound by the methylation in the microalgae as mentioned above from the viewpoint of reducing the toxicity of the harmful compound. Moreover, the harmful compound is preferably converted to the dimethylated compound in the above microalgae from the viewpoint of converting it to more harmless compound by obtaining a high value of LD₅₀, and from the viewpoint of making it easy to obtain the trimethyl compound which is more harmless.

Moreover, in the detoxification method of the present invention, it is preferable to convert the harmful compound monomethylated and/or dimethylated by the methylation in the microalgae into the dimethyl compound and/or the trimethyl compound by the methylation in the larval zooplankton from the viewpoint of further reducing the toxicity of the harmful compound. Moreover, the monomethylated and/or dimethylated harmful compound are more preferably converted to the trimethylated compound in the above larval zooplankton from the viewpoint of converting it to more harmless compound by obtaining a higher value of LD₅₀.

As the monomethyl compound detoxified from the harmful compound containing arsenic, mention may be made of monomethyl arsonic acid, monomethyl arsinic acid etc. Moreover, as the dimethyl compound of the harmful compound containing arsenic, mention may be made of arsenosugar, dimethylarsinic acid, dimethylarsinoyl acetate (DMAA), dimethylarsinoyl ethanol (DMAE), dimethylarsinoyl propionate (DMAP) etc.

As the trimethyl compound of the harmful compound containing arsenic, mention may be made of arsenocholine, arsenobetaine and trimethylarsineoxide etc. Among them, the trimethylated compound is preferably made of arsenobetaine, more preferably, made of 60% or more of arsenobetaine among the trimethylated compound, further more preferably, made of 90% or more of arsenobetaine from the viewpoint that it is chemically stable, has an resistance for the degradation in nature and very low toxicity.

As the monomethyl compound detoxified from the harmful compound containing antimony, mention may be made of monomethylantimony etc. Moreover, as the dimethyl compound of the harmful compound containing antimony, mention may be made of dimethylantimony etc. Moreover, as the trimethyl compound of the harmful compound containing antimony, mention may be made of trimethyl antimony, trimethylantimony dihydroxide, trimethylantimony dichloride etc.

As the monomethyl compound detoxified from the harmful compound containing selenium, mention may be made of monomethyl selenol, an organic compound containing monomethyl selenium etc. Moreover, as the dimethyl compound of the harmful compound containing selenium, mention may be made of dimethylselenium, dimethylselenide etc. Moreover, as the trimethyl compound of the harmful compound containing selenium, mention may be made of trimethylselenium etc.

The detoxification of the harmful compound using the microalgae—the larval zooplankton may be carried out by the following manner etc. Namely, at first, the microalgae is cultured at the culture medium containing the harmful compound to accumulate the harmful compound into the cell of the microalgae. And then, the accumulated harmful compound may be methylated by the biological enzyme of the microalgae, to convert it into the monomethyl compound and/or the dimethyl compound which is a harmless substance. Next, the microalgae containing the monomethyl compound and/or the dimethyl compound may be accumulated in the larval zooplankton. And then, the monomethyl compound and/or the dimethyl compound may be methylated by the biological enzyme of the larval zooplankton to convert it to more harmless substances, that is, the dimethyl compound and/or the trimethyl compound.

The culture method is not specifically limited, it is possible to use a conventional procedure.

The larval zooplankton may be obtained by hatching the egg of the zooplankton, such method of hatching and culturing them is not specifically limited, it is possible to use a conventional procedure.

Further, in a preferred embodiment, the concentration of the inorganic arsenic is reduced to less or equal to a concentration of an inorganic arsenic contained in a sea food of nature, and the inorganic arsenic is converted to a harmless organic arsenic. At this moment, the term “less or equal to a concentration of an inorganic arsenic contained in a sea food of nature” means less or equal to a concentration of an inorganic arsenic naturally contained in a sea food under the circumstance with no contamination caused by arsenic etc. That is, according to the method of the present invention, by using the food chain system containing the larval zooplankton, it is possible to reduce the concentration of the inorganic arsenic to less or equal to that contained in the sea food of nature in the food chain system simultaneously to convert it to more stable and harmless organic arsenic.

### EXAMPLE

The present invention will be explained with reference to Examples, but the invention is not intended to be interpreted as being limited to Examples.

### Example 1

An accumulation examination and content test of the arsenic concerning the chlorella, the artemia and the shellfish were carried out as follows.

(1) An accumulation examination of arsenic concerning the chlorella 500 g of the chlorella (chlorella regularis, Nippon Chlorella) was cultured (number of cells pre 1 mL: 5.4×10⁹ pieces) using a culture apparatus (5 L culture bath) to accumulate sodium arsenite into the cell of the chlorella. The culture time was for 3 days. The culture was carried out in 1 L of the culture medium containing 1 ppm of sodium arsenite (trivalent inorganic arsenic) under illumination, at 25° C., with 1 L/minute of the air flow. After the culture, the algal cells of the chlorellas were harvested by using the centrifugation.

(2) An accumulation examination of arsenic concerning the artemia 1 g of marine-derived planktons, artemias (Artemia salina, Tetra Co., Ltd.) were bred by supplying 1 g of the chlorella including the above sodium arsenite as a bait. A breeding period of the artemias was for 1 day. The artemias were bred in a glass bath containing 2 L of an artificial seawater (Highpet) at 25° C. After breeding, the artemias were collected by the centrifugation.

(3) An accumulation examination of arsenic concerning the shellfish The shellfishes (Metapenaeus ensis) were bred by paving the sea sand in 30 cm×30 cm×50 cm of the glass water bath, and adding 20 L of an artificial seawater (Highpet) with the air flow. A feeding was carried out every 3 days, the artemias were fed with totally 4 times in 4 weeks.

(4) A Content Test of Arsenic

After the accumulation test, the inorganic arsenic and organic arsenic existing in the organism were examined. The content test of the inorganic arsenic and organic arsenic was carried out by using an arsenic analysis system for various sort of the appearance (Shimadzu Corporation, atomic absorption spectro photometer AA-6800, pretreatment system ASA-2 sp). Moreover, the content of arsenic was examined by a wet weight in the content test. The result of this is shown in table 2. From the above result, it was confirmed that the detoxified arsenic was concentrated in only oyster, that is a part of the body (flesh).

TABLE 2

| | An amount of | Mehylated | Dimethylated | Detoxified |
|---|---|---|---|---|
| | inorganic | arsenic | arsenic | arsenic, |
| | arsenic | (monomethyl- | (dimethyl- | trimethylated |
| | ppm μg | arsineoxide) | arsineoxide) | arsenic |
| | arsenic/ | ppm μg arsenic/ | ppm μg arsenic/ | ppm μg arsenic/ |
| | wet weight g | wet weight g | wet weight g | wet weight g |
| Oyster | — | — | 0.592 | 2.82 |
| Untreated blank | | | | |
| Part of body | | | | |
| Oyster | — | — | 0.803 | 6.582 |
| 4 weeks | | | | |
| Part of body | | | | |
| Oyster | 0.024 | — | 0.01 | 0.023 |
| 4 weeks | | | | |
| Part of shell | | | | |

### Example 2

As the example containing only dimethylated arsenic (which is thought as arsenosugar), the artemia was obtained which is actually used in the cultural fishery, the content amount of arsenic was examined by the same manner as the above example 1, actually. As a result, the dimethylated arsenic (dimethyllarsineoxide) was only detected in the artemia par wet weight as the arsenic compound. This content amount was 0.397 ppmμ g arsenic/wet weight g.

As to this, an accumulation examination for 1 week was carried out for the oyster by the same manner as mentioned above. Moreover, an accumulation examination was carried out by adding 10 mM of glutathione in the sea water for a part of the sample. Moreover, an accumulation examination was carried out by adding 1 ppm of sodium arsenite in the artificial sea water with no feeding for 1 week and 2 weeks in order to confirm the ability of the methylation of arsenic concerning the oyster.

These results is shown in table 3. In the part of only oyster, it is possible to accumulate the detoxified arsenic which is mainly made of trimethylasenic (arsenobetaine) even if the stating material is the dimethyl arsenic compound. Moreover, the ability of the methylation of arsenic was confirmed because the content amount of the inorganic arsenic contained in only oyster was clearly reduced for 1 week to 2 weeks, even the system comprising adding the inorganic arsenic.

TABLE 3

| | An amount of | Mehylated | Dimethylated | Detoxified |
|---|---|---|---|---|
| | inorganic | arsenic | arsenic | arsenic, |
| | arsenic | (monomethyl- | (dimethyl- | trimethylated |
| | ppm μg | arsine oxide) | arsineoxide) | arsenic |
| | arsenic/ | ppm μg arsenic/ | ppm μg arsenic/ | ppm μg arsenic/ |
| | wet weight g | wet weight g | wet weight g | wet weight g |
| Oyster | — | — | 0.592 | 2.82 |
| Untreated blank | | | | |
| Part of body | | | | |
| Oyster + artemia | — | — | 0.381 | 3.96 |
| 1 week | | | | |
| Part of body | | | | |
| Oyster + artemia + | — | — | 0.51 | 4.62 |
| glutathione | | | | |
| 1 week | | | | |
| Part of shell | | | | |
| Oyster + inorganic | 1.87 | 0.111 | 2.451 | 3.77 |
| arsenic | | | | |
| 1 week | | | | |
| Part of body | | | | |
| Oyster + inorganic | 0.476 | 0.127 | 1.243 | 4.01 |
| arsenic | | | | |
| 2 weeks | | | | |
| Part of body | | | | |

### Example 3

In the present Example, the detoxification of arsenous acid was examined by accumulating arsenous acid as the compound containing arsenic into the microalgae, nannochloropsis. The procedure and the result of these is explained as follows.

(1) culture of the microalgae

The microalgae, nannochloropsis (nannochloropsis oculata) cultivated in advance until a logarithmic growth phase was inoculated so as to obtain a 1×10⁶ cells/mL in 1 L medium made of a DAIGO (Dulbecco's Modified Eagle) artificial seawater sp (Wako Pure Chemical Industries, Ltd.) and a DAIGO IMK medium (Wako Pure Chemical Industries, Ltd.) and was cultured under exposure to the fluorescent light at a temperature of 25° C.

(2) Accumulation Test of Arsenic

The accumulation test of arsenic was carried out by adding sodium arsenite to the culture medium to obtain 1 ppm as a metal arsenic 48 hours after starting the inoculation, and then culturing them under exposure to the fluorescent light as a temperature of 25° C. for 120 hours after the addition of arsenic.

(3) Measurement of the Content of Arsenic

The quantitative analysis concerning the inorganic arsenic and the organic arsenic contained in alga body was carried out by using an arsenic analysis system for various sort of the appearance (Shimadzu Corporation, atomic absorption spectro photometer AA-6800, pretreatment system ASA-2sp) with taking a sample of the alga body chronologically by the centrifugation.

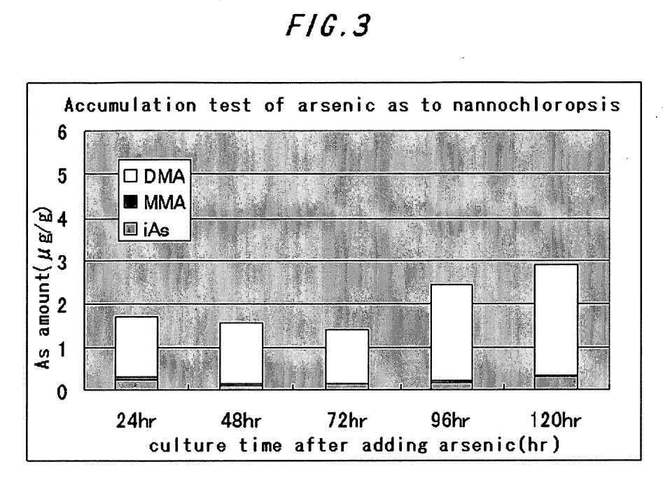

FIG. 3 shows the time-dependent changes of the concentration of the inorganic arsenic and the organic arsenic which is accumulated in the alga body, and the concentration of the alga body. At this moment, the “iAs”, “MMA” and “DMA” show the inorganic arsenic, the monomethylated arsenic compound, and the dimethylated arsenic compound, respecitively.

It is clear from this figure that the added arsenic was accumulated in the alga body of nannochloropsis (In the case of no addition of arsenic, a total arsenic concentration in the alga body is 0.02 μg/g wet cells). The accumulation amount of arsenic tended to be higher with the age of culture. Most of the inorganic arsenic accumulated in the alga body was dimethylated.

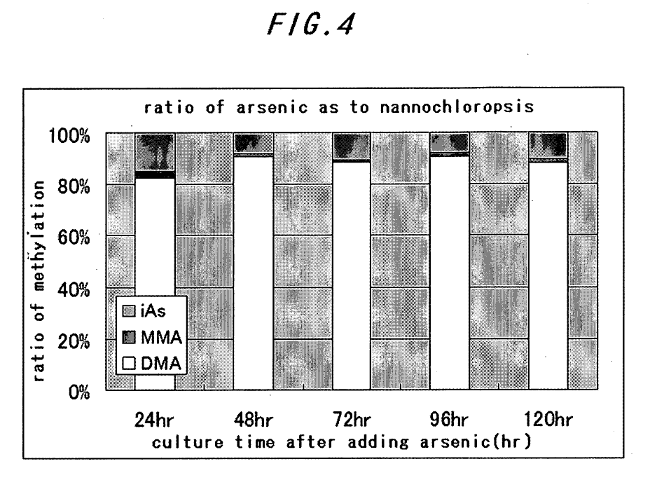

FIG. 4 shows a percentage of the inorganic arsenic, the monomethylated arsenic compound, and the dimethylated arsenic compound accumulated in the alga body.

In any time of culture, 80% or more of the accumulated arsenic existed as the dimethylated arsenic compound, as a result of this, the remnant of the inorganic arsenic was very small.

### Example 4

Next, the experiment of obtaining more harmless trimethylated arsenic compound by accumulating nannochloropsis containing the dimethylated arsenic compound of the Example 3 into the artemia was carried out by using the artemia as the zooplankton. The procedure and the result of this will be explained as follows.

(1) Hatch of artemia

The hatching test was carried out by adding 1 g of the artemia (Tetra,

1 L of the DAIGO (Dulbecco's Modified Eagle) artificial seawater sp (Wako Pure Chemical Industries, Ltd.), with bubbling at a temperature of 25° C. for 48 hours. 3 g of the larvas of the hatched artemia (nauplius stage) were separated by the nylon mesh (100 μm), and washed by the artificial sea water. Among them, about 1.5 g of the artemia larvas were used as the reference sample for the no additional of arsenic.

(2) Preparation of the Adult artemia

The adult artemia having the order of the 1 cm in length were obtained by accumulating nannochloropsis containing no arsenic compound for 2 months into the artemia which is hatched by the same manner as mentioned above. 0.7 g of the adult artemias were separated by the nylon mesh (100 μm), and washed by the artificial sea water.

(3) Accumulation Test of Arsenic

About 1.5 g of the larval artemias immediately after hatching and about 0.7 g of the adult artemias were bred by adding them to 200 mL of the artificial sea water at 25° C. under the aeration. The accumulation test was carried out by adding 100 mg/wet weight of the nannochloropsis containing the dimethylated arsenic compound produced in the Example 3 every 24 hours for three times, and accumulating it to the above larval artemias and adult artemias.

(4) Preparation of Arsenic Sample for Analysis

1.55 g of the larval artemias and 0.755 g of the adult artemias were obtained by separating the larval artemias from the adult artemias with the use of the nylon mesh for which the above accumulation test of arsenic were conducted. Each of the separated artemias was washed on the nylon mesh with the distilled water.

The samples for the analysis were prepared by extracting in 20 mL of 50% of the methanol solution in three times each of the artemias after separating and washing, and drying and solidifying the extracted solution under reduced pressure, and then solving the produced solid extract to 1 mL of the purified water. Moreover, the samples for the analysis were prepared by carrying out the same extracting treatment as mentioned above with the use of 1.5 g of the larval artemias separated immediately after hatching as a control with no addition of arsenic.

(5) Topology Analysis of Arsenic

The topology analysis of arsenic was carried out by using the ICP-MS (Agilent 7500 cc System) as a detector of arsenic with the HPLC made by Agilent (Agilent 1100 System). The table 4 shows a result that the analysis of the arsenic compound concerning the extract sample of the artemias was carried out by using the cation-exchange column, Shodex Rspak NN-414 (4.6 mm I.D.×150 mm), with HPLC-ICP-MS. The table 4 shows a result of the topology analysis of arsenic existing in the extracted solution of the artemias.

TABLE 4

| | Weight of | Total amount | Concentration | Concentration of arsenic in artemia | | | |
|---|---|---|---|---|---|---|---|
| Samples | added | of arsenic in | of arsenic in | Inorganic | Dimethylated | Arseno- | Total |
| of | algae | added algae | added algae | arsenic | arsenic | betaine | arsenic |
| artemia | g wet | μg | μg/g | μg/g | μg/g | μg/g | μg/g |
| Larva(no | 1.412 | 0 | 0 | 0.003 | 0.768 | 0.107 | 0.878 |
| added) | | | | | | | |
| Larva | 1.550 | 0.756 | 0.488 | 0.006 | 1.180 | 0.167 | 1.353 |
| (added) | | | | | | | |
| Adult | 0.755 | 0.915 | 1.212 | 0.000 | 0.486 | 0.054 | 0.540 |
| (added) | | | | | | | |

It was confirmed that the larva of the artemia contained the dimethylated arsenic compound (arsenosugar) and arsenobetaine as a background even no addition of arsenic. As a result of the accumulation test of arsenic, the concentration of the dimethylated arsenic compound and arsenobetaine in the larval artemia increased. The increase of the dimethylated arsenic compound depended on uptaking the nannochloropsis containing the dimethylated arsenic compound. The increase of arsenobetaine depended on the result of the biosynthesis of from the dimethyl compound of arsenic to arsenobetaine, that is the trimethyl compound in the organism of the larval artemia. As these result, arsenobetaine increased 1.6 folds compared to those of the larval artemia cultured under the conditions of no addition of arsenic. On the other hand, it is estimated that in the adult artemia the concentration of the dimethylated arsenic compound and arsenobetaine is low, and therefore, an ability of the biosynthesis of arsenobetaine is low.

### INDUSTRIAL APPLICABILITY

A new treating method of arsenic using the food chain system containing the shellfish class was provided by the present invention. In particular, the shellfish class makes it possible to separate them more efficiently by detoxifying and methylating arsenic industrially compared to the prior art because it is easy to separate a part of their flesh from a part of their shell. Further, it provides a method capable of methylating arsenic with reducing the residual amount of the inorganic arsenic which is the most dangerous substance among them by using the organism having an ability of methylating itself, for example oyster etc.

1. A method of detoxifying a harmful compound, wherein an element selected from the group comprising arsenic, antimony and selenium, or a harmful compound containing at least one element selected from the group comprising arsenic, antimony and selenium is converted to a harmless substance using a food chain system.

2. A method of detoxifying a harmful compound according to claim 1, wherein using the food chain system at least one element selected from the group comprising arsenic, antimony and selenium is converted to a harmless substance produced by the food chain system.

3. A method of detoxifying a harmful compound according to claim 1, wherein the food chain system is a phytoplankton—a zooplankton.

4. A method of detoxifying a harmful compound according to claim 3, wherein the food chain system further comprises a shellfish after the zooplankton.

5. A method of detoxifying a harmful compound according to claim 3, wherein the phytoplankton is a microalgae.

6. A method of detoxifying a harmful compound according to claim 5, wherein the microalgae is a chlorella.

7. A method of detoxifying a harmful compound according to claim 3, wherein the zooplankton is an artemia or a rotifer.

8. A method of detoxifying a harmful compound according to claim 1, wherein the food chain system comprises feeding a solution containing an organism and/or a dimethylated arsenic compound or cacodylic acid to the shellfish.

9. A method of detoxifying a harmful compound according to claim 4, wherein the shellfish is a shellfish capable of being farmed.

10. A method of detoxifying a harmful compound according to claim 9, wherein the shellfish is an oyster.

11. A method of detoxifying a harmful compound according to claim 1, wherein the shellfish is bred in the presence of a methylating accelerator factor.

12. A method of detoxifying a harmful compound according to claim 11, wherein the methylating accelerator factor is glutathione, S-adenosylmethionine or sulforaphane.

13. A method of detoxifying a harmful compound according to claim 1, wherein the concentration of the inorganic arsenic is reduced to less or equal to a concentration of an inorganic arsenic contained in a sea food of nature, and the inorganic arsenic is converted to a harmless organic arsenic.

14. A method of detoxifying a harmful compound according to claim 1, wherein the harmful compound containing at least one element selected from the group comprising arsenic, antimony and selenium is converted to a harmless substance using a food chain system containing a zooplankton in the larval stage.

15. A method of detoxifying a harmful compound according to claim 14, wherein the element is arsenic.

16. A method of detoxifying a harmful compound according to claim 14, wherein the food chain system is a food chain system made of a microalgae—a zooplankton in the larval stage.

17. A method of detoxifying a harmful compound according to claim 14, wherein the harmful compound is converted to the harmless substance by methylating the harmful compound using a biological enzyme of the microalgae and the larval zooplankton.

18. A method of detoxifying a harmful compound according to, wherein the microalgae is a marine-derived microalgae.

19. A method of detoxifying a harmful compound according to claim 18, wherein the marine—derived microalgae is a microalgae which is belong to Nannochloropsis genus.

20. A method of detoxifying a harmful compound according to claim 14, wherein the zooplankton is an artemia.

21. A method of detoxifying a harmful compound according to claim 17, wherein the harmful compound is converted to a monomethyl compound, a dimethyl compound and/or a trimethyl compound by the methylation.

22. A method of detoxifying a harmful compound according to claim 21, wherein the dimethyl compound is at least one selected from the group comprising arsenosugar, dimethylarsinic acid, dimethylarsinoyl acetate (DMAA), dimethylarsinoyl ethanol (DMAE), dimethylarsinoyl propionate (DMAP).

23. A method of detoxifying a harmful compound according to claim 21, wherein the trimethyl compound is at least one selected from the group comprising arsenocholine, arsenobetaine and trimethylarsineoxide.

24. A method of detoxifying a harmful compound according to claim 21, wherein the trimethyl compound is made of arsenobetaine.

25. A method of detoxifying a harmful compound according to claim 14, wherein the concentration of the inorganic arsenic is reduced to less or equal to a concentration of an inorganic arsenic contained in a sea food of nature, and the inorganic arsenic is converted to a harmless organic arsenic.
